(19) United States
(12) Patent Application Publication
(10) Pub. No.: US 2020/0233724 A1
(43) Pub. Date: Jul. 23, 2020

(54) WORKLOAD PLACEMENT IN A CLUSTER COMPUTING ENVIRONMENT USING MACHINE LEARNING

(71) Applicant: NEC Laboratories Europe GmbH, Heidelberg (DE)

(72) Inventors: Florian Schmidt, Dossenheim (DE); Giuseppe Siracusano, Heidelberg (DE); Roberto Bifulco, Heidelberg (DE)

(21) Appl. No.: 16/454,154

(22) Filed: Jun. 27, 2019

Related U.S. Application Data
(60) Provisional application No. 62/793,393, filed on Jan. 17, 2019.

(51) Int. Cl. G06F 9/50; G06F 11/34; G06F 11/30

(52) U.S. Cl. CPC G06F 9/5083; G06F 11/3024; G06F 9/505; G06F 11/3433

(57) ABSTRACT

A method for allocating a workload to a cluster machine of a plurality of cluster machines which are part of a computer cluster operating in a cluster computing environment, includes the step of collecting values from hardware performance counters of each of the cluster machines while the cluster machines are running different workloads. A value of a hardware performance counter from a system which executed the workload to be allocated in isolation and the values from the hardware performance counters of each of the cluster machines which are running the different workloads are used as input to a machine learning algorithm trained to provide as output in each case a prediction of a performance of the workload on each of the cluster machines which are running the different workloads. The cluster machine is selected for placement of the workload based on the predictions.

### CROSS-REFERENCE TO PRIOR APPLICATION

Priority is claimed to U.S. Provisional Application No. 62/793,393 filed on Jan. 17, 2019, the entire contents of which is hereby incorporated by reference herein.

### FIELD

The present invention relates to cluster computing environments in which a plurality of computational resources or different cluster machines collaboratively execute computational workloads, and in particular, to methods and systems which use machine learning for allocating the computational resources in the cluster computing environment.

### BACKGROUND

Placement of workloads in a cluster is a generic, well-known, and classic problem: given a cluster of machines with workloads already running on them, which machine should a new workload be scheduled on for optimal performance? Simple solutions include round-robin assignment to machines, or choosing the machine with the lowest number of currently running jobs. However, correct placement can be complicated, because different workloads tend to have different effects on each other (the “noisy neighbor effect”): a good example is two workloads that are both I/O-heavy, which can both perform at much less than 50% of their performance when run together due to a phenomenon known as thrashing.

More elaborate solutions require prior knowledge about the running workloads, e.g., which workloads are running on each machine and what is the new workload that has to be allocated. Making this information available requires detailed knowledge about running applications, and solutions for performing resource allocation need to rely on hand-crafted heuristics that are tuned for the target workloads, hardware and applications.

U.S. Pat. No. 9,959,146 B2 describes a method of scheduling workloads to computing resources of a data canter which predicts operating values for the computing resources for the scheduling.

### SUMMARY

In an embodiment, the present invention provides a method for allocating a workload to at least one cluster machine of a plurality of cluster machines which are part of a computer cluster operating in a cluster computing environment. Values from hardware performance counters of each of the cluster machines are collected while the cluster machines are running different workloads. A value of a hardware performance counter from a system which executed the workload to be allocated in isolation and the values from the hardware performance counters of each of the cluster machines which are running the different workloads are used as input to a machine learning algorithm trained to provide as output in each case a prediction of a performance of the workload on each of the cluster machines which are running the different workloads. The at least one cluster machine is selected for placement of the workload based on the predictions.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a graphical representation of the resource allocation problem solved by embodiments of the present invention;

FIG. 2 is a schematic view of a method and system for predicting the performance of a cluster machine in accordance with an embodiment of the present invention; and

FIG. 3 is a schematic view of a method of training and making predictions using a machine learning algorithm in accordance with an embodiment of the present invention.

### DETAILED DESCRIPTION

Embodiments of the present invention solve the resource allocation problem in a computer cluster using a machine learning method that combines information from hardware performance counters of the computers in the cluster to make an application placement decision, with no additional prior knowledge about application details and the running workloads on the target computers.

Embodiments of the present invention further provide a more automated and effective approach for solving the resource allocation problem in a computer cluster. Preferably, the approach includes continuously collecting data from all machines in the cluster to characterize the load on the system. To keep this overhead low, an embodiment of the present inventions focuses on hardware performance counters, which can be collected with hardware support in commodity central processing units (CPUs), such as with the x86 instruction set architectures, at very little overhead. In addition, a workload is profiled once on its own to collect the same performance counters. This can happen during development time or once when allocating a new application or workload.

According to an embodiment, the present invention then takes the hardware performance counters data of the workload running alone, as well as the data from each cluster machine, to execute a placement decision that optimizes the performance (e.g., decided by an arbitrary, user-defined key performance indicator (KPI)) for this new workload. To predict how well a given workload would run on a given machine, a machine learning algorithm, based on artificial neural networks, is used.

In an embodiment, the present invention provides a method for allocating a workload to at least one cluster machine of a plurality of cluster machines which are part of a computer cluster operating in a cluster computing environment. Values from hardware performance counters of each of the cluster machines are collected while the cluster machines are running different workloads. A value of a hardware performance counter from a system which executed the workload to be allocated in isolation and the values from the hardware performance counters of each of the cluster machines which are running the different workloads are used as input to a machine learning algorithm trained to provide as output in each case a prediction of a performance of the workload on each of the cluster machines which are running the different workloads. The at least one cluster machine is selected for placement of the workload based on the predictions

In a same or different embodiment, the machine learning algorithm is trained to provide as the output in each case a KPI worsening factor representing a ratio of an expected KPI of the workload on each of the cluster machines which are running the different workloads and a measured KPI from the system which executed the workload to be allocated in isolation. The at least one cluster machine predicted to have the lowest KPI worsening factor is selected for placement of the workload.

In a same or different embodiment, the input to the machine learning algorithm further includes in each case a number of the different workloads currently running on each of the cluster machines.

In a same or different embodiment, the machine learning algorithm uses an artificial neural network as a machine learning model.

In a same or different embodiment, the values of the hardware performance counters are combined with each other.

In a same or different embodiment, the method further comprises: executing the workload after placement of the workload on the at least one cluster machine concurrently with at least one other workload; collecting values from the hardware performance counters of the at least one cluster machine and measuring a KPI while the at least one cluster machine executes the workload concurrently with the at least one other workload; and using the values of the hardware performance counters of the at least one cluster machine and the measured KPI as training data for the machine learning algorithm.

In a same or different embodiment, the machine learning algorithm follows construction rules of a multi-layer perceptron.

In a same or different embodiment, the method further comprises executing a new workload in the system in isolation, or in another system or one of the cluster machines in isolation, and collecting values from the hardware performance counters during execution of the new workload.

In a same or different embodiment, the method further comprises receiving a user-specified KPI characterizing the performance of the workload.

In another embodiment, the present invention provides a system for allocating a workload to at least one cluster machine of a plurality of cluster machines which are part of a computer cluster operating in a cluster computing environment. The system comprises memory and one or more computer processors which, alone or in combination, are configured to provide for execution of a method comprising: collecting values from hardware performance counters of each of the cluster machines while the cluster machines are running different workloads; using a value of a hardware performance counter from a system which executed the workload to be allocated in isolation and the values from the hardware performance counters of each of the cluster machines which are running the different workloads as input to a machine learning algorithm trained to provide as output in each case a prediction of a performance of the workload on each of the cluster machines which are running the different workloads; and selecting the at least one cluster machine for placement of the workload based on the predictions.

In a same or different embodiment, the machine learning algorithm is trained to provide as the output in each case a KPI worsening factor representing a ratio of an expected KPI of the workload on each of the cluster machines which are running the different workloads and a measured KPI from the system which executed the workload to be allocated in isolation. The at least one cluster machine predicted to have the lowest KPI worsening factor is selected for placement of the workload.

In a further embodiment, the present invention provides a tangible, non-transitory computer-readable medium having instructions thereon which, upon execution by one or more processors with access to memory, provides for execution of the method for allocating a workload according to an embodiment of the invention.

In an even further embodiment, the present invention provides a method for training a machine learning algorithm for use in allocating workloads to cluster machines which are part of a computer cluster operating in a cluster computing environment. Values from hardware performance counters of each of the cluster machines which are running a first workload concurrently with other workloads are collected and a KPI while the cluster machines are running the first workload is measured. The values from the hardware performance counters of each of the cluster machines are combined in each case with a value from a hardware performance counter of a system that executed the first workload in isolation. The combined values from the hardware performance counters are provides in each case as input to the machine learning algorithm and using the measured KPI for output labels such that the machine learning algorithm adapts its weights and parameters based thereon.

In a same or different embodiment, wherein the output labels are in each case a KPI worsening factor representing a ratio of the measured KPI of the first workload on each of the cluster machines and a measured KPI from the system which executed the first workload in isolation.

In another embodiment, the present invention provides a tangible, non-transitory computer-readable medium having instructions thereon which, upon execution by one or more processors with access to memory, provides for execution of the method for training the machine learning algorithm according to an embodiment of the invention.

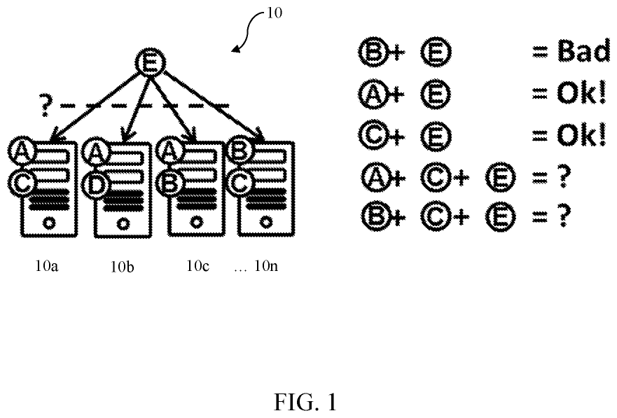

FIG. 1 schematically illustrates a resource allocation decision which must be made for a new workload E in a computer cluster 10 networked in a cluster computing environment including cluster machines 10a, 10b, 10c . . . 10n which are each running one or more other workloads A, B, C and D. Embodiments of the present invention can be used to predict how the new workload E would perform if combined with other ones of the workloads A, B, C, and/or D on different ones of the cluster machines 10a, 10b, 10c . . . 10n. The cluster machines 10a, 10b, 10c . . . 10n can be separate physical computers with a standard operating system or can be virtual machines.

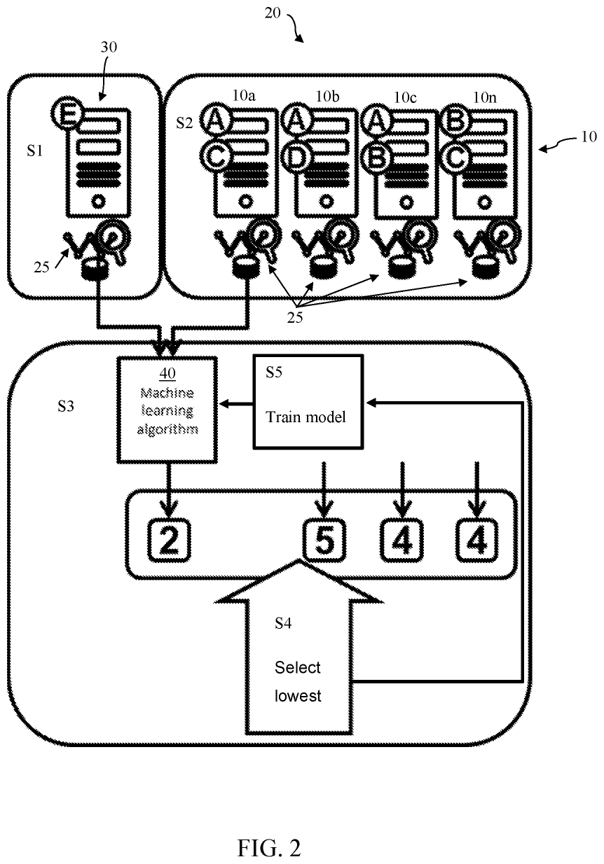

According to an embodiment schematically illustrated by the prediction system 20 of FIG. 2, the present invention provides a method comprising the following steps:
S1. Characterization of new workload. This step only has to be performed once each time a new workload E is added that the prediction system 20 has never seen before. In this case, the user specifies with the new workload E a KPI that characterizes the system's performance, as well as a way to extract the KPI. For example, the user can manually identify a KPI (for example, memory throughput for a memory-heavy application), and specify a way to read out of the KPI. For many practical workloads, this can be fairly straightforward. For example, for a database (or web) server, a small database benchmark (or a tool such as apachebench for the web server, respectively) could be used, which is a straightforward way to define the KPI (by leveraging best practices of the domain) and to obtain the KPI measurement as well (by checking the output of the benchmark). The workload E is then run on a computer system 30, for example, comprising one or potentially more cluster machines being run at least for step S1 in isolation, for initial characterization in a system without noise, and the values from the hardware performance counters 25 and KPI are saved for future use. The hardware performance counters 25 are registers built into the CPUs of the computer system 30 and cluster machines 10a, 10b, 10c . . . 10n which store the counts of hardware-related activities or events within computer system 30 and the individual cluster machines 10a, 10b, 10c . . . 10n. Such hardware performance counters 25 are typically available for most CPUs. While any hardware performance counter 25 could be used, preferably one or a subset of the available hardware performance counters 25 are used that correlate well with scheduling effects and would characterize different loads, for example, cache hits+misses on the different levels of caches (correlating with data locality of workloads), CPU instructions per cycle (correlating with how computation-heavy a workload is as opposed to, e.g., I/O heavy), etc.
S2. Information extraction. As workloads A, B, C and D are running in the computer cluster 10, values from hardware performance counters 25 characterizing the overall load on each cluster machine 10a, 10b, 10c . . . 10n (comprising one or more actual workload items A, B, C and/or D) are collected, preferably at regular intervals. In addition, each workload has a user-defined KPI provided in step S1 that characterizes the performance (this can, for example be the number of signature checks a cryptographic signing system can perform; the number of requests processed by a web or database server; etc.). This KPI is also collected in regular intervals in step S2 while the workloads A, B, C and D are running in different combinations on the cluster machines 10a, 10b, 10c . . . 10n. Thus, the user-defined KPI is collected once during the initial characterization when the different workloads A, B, C and D are new to the prediction system 20 and are run on their own in isolation so that the prediction system 20 understands (a) how the workload stresses the hardware, and which components, and (b) what performance can be expected when the workload is run in isolation, so that later on, the KPI measured intermittently in step S2 can be compared to the initial KPI. For example: on its own, the workload “web server www.abc.eu” initially produced a KPI of “10000 requests served per second”, while after co-location, it only reached “5000 requests served per second.” Thus, in this example, it can be determined that the user-specified KPI (and thus the performance the user of the workload cares about) deteriorated by 50%. In other words, the user-defined KPI for a new workload is only collected once. Later, it is then collected intermittently when the workload is run concurrently with co-located workloads on the same machine, because running several jobs concurrently usually has detrimental effects on the KPI. A simple example would be as follows: Two CPU-heavy applications running concurrently will have to share the CPU, so each application's KPI is expected to worsen by about 50% (in practice, often more than 50%, because co-scheduling produces overhead).
S3. Prediction of performance for each cluster machine. The information that characterizes a certain workload E (collected in step S1) is combined with the current performance indication for each cluster machine 10a, 10b, 10c . . . 10n (collected in step S2), and a machine learning algorithm 40 is run to predict in each case the performance of the new workload E if run on the respective cluster machine 10a, 10b, 10c . . . 10n. In particular, the values are combined into an input vector. The input to the ML algorithm (for example, a neural network) is a number of values that together form the information available to do a prediction on. In embodiments of the present invention, the performance counters collected in the initial training phase (workload run in isolation) or step S1, and which give a general characterization of the behavior of the workload, are combined with the performance counters currently collected on machine 10a (which gives a characterization of the current load of machine 10a) by concatenating the two sets of values. The ML algorithm then runs a prediction on that vector of values. The performance counters collected in the initial training phase are combined with the performance counters currently collected on machine 10b to get another prediction, etc. Those predictions can then be compared to find the machine that is, under the current load, best suited to run the workload. While it is possible for the machine learning algorithm 40 to be trained on and then predict raw KPI values as measured (e.g., “5000 requests served per second”), the prediction performance can be improved and training time can be reduced by predicting a “KPI worsening factor” instead. This is especially true if the raw KPI values for the considered applications vary in range and magnitude. This worsening factor predicts how much the KPI of the workload E will worsen when run on each one of the cluster machines 10a, 10b, 10c . . . 10n compared to running on an empty machine on its own. This is advantageous since the raw KPI values are typically not normalized. For a web server, “10000 requests served per second” might be a decent number, but for a more computationally expensive workload “5 items calculated per second” might be a reasonable number. If the value ranges for the KPIs between the different workloads differ that strongly, the ML algorithms could face challenges learning to correctly predict behavior. It is therefore advantageous according to a preferred embodiment of the present invention to normalize the KPI values by using the value of the KPI (e.g., 10000 or 5) as a reference value of 1, and then “5000 requests per second” would by division yield a KPI worsening factor of 2, and “1 item calculated per second” would yield a KPI worsening factor of 5. Thus, the value range of the predicted values is much smaller, which aids the predictive performance of the ML algorithm, and thus, predicting the worsening factor as the predicted output of the ML algorithm (with the input vector as described above) is generally preferred.
S4. Choosing a cluster machine. By taking the information predicted in step S3 for each of the cluster machines 10a, 10b, 10c . . . 10n, a choice can now be made on which cluster machine 10a, 10b, 10c . . . 10n to run the workload E. This can be done by selecting the cluster machine 10a, 10b, 10c . . . 10n predicted to provide the best KPI or, in accordance with another embodiment, the lowest KPI worsening factor (e.g., see “select lowest” in FIG. 2).
S5. Updating the model. As the workload E runs on the machine, the continuously collected performance counter information as well as the KPI information provides feedback of the ground truth of how well workload E performs in combination with the other co-located workloads. For example, if cluster machine 10a is selected in step S4, then actual performance information regarding how workload E performs in combination with co-located workloads A and C is collected. This information can then be used to further train the model used by the machine learning algorithm 40. Preferably, the model used by the machine learning algorithm 40 is an artificial neural network.

The prediction system 20 can be bootstrapped by starting with an empty model with no information and using a preexisting standard algorithm (such as round-robin deployment) for placement of workloads. As data is collected about the behavior of co-located workloads, the model used by the machine learning algorithm 40 of step S3 can be trained with this data and then be used to make placement decisions, with the predictions becoming more accurate as the results of placement decisions are collected and fed into the model for regular retraining.

In contrast to U.S. Pat. No. 9,959,146 B2, embodiments of the present invention are able to predict the performance of a workload when put on different cluster machines, and then is able to decide where to put it, based on that prediction. U.S. Pat. No. 9,959,146 B2 does not describe any way to predict or optimize the performance of a workload, but rather describes a way to predict how a workload will impact overall load on different machines. Thus, U.S. Pat. No. 9,959,146 B2 has a machine-centered which provides to schedule workloads in a manner which does not overload the machines, while embodiments of the present invention have a workload-centered view and optimize the performance of that workload. Accordingly, embodiments of the present invention advantageously provide for the allocation of computer resources in a manner that enhances system performance by providing for better performance of incoming workloads by the placement decisions made in accordance with embodiments of the present invention, thereby saving time, computational costs and effort, and freeing up computational resources for other workloads.

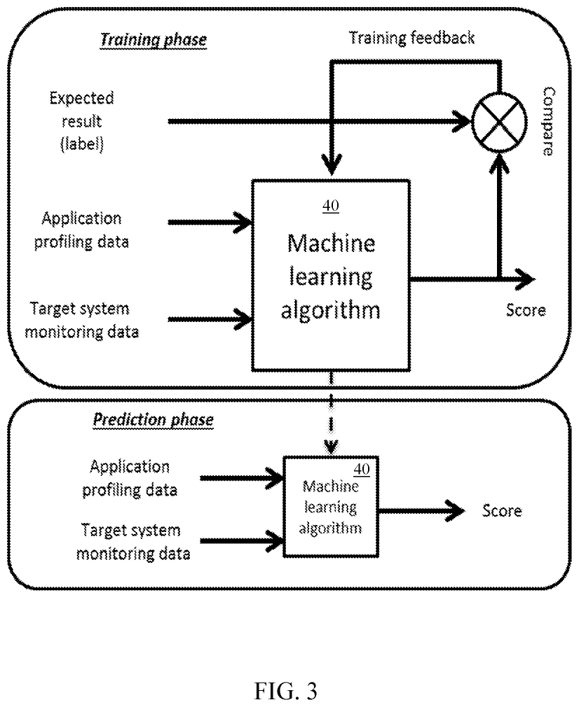

FIG. 3 is a schematic representation of the training and prediction phases of the machine learning algorithm 40 used in step S3 and updated in step S5. In the following, the machine learning algorithm 40 is described in more detail.

The input of the machine learning algorithm 40 include application profiling data such as the hardware performance counter measurements during the stand-alone execution of the application workload that is to be placed, and target system monitoring data such as the current hardware performance counter measurements of the machine for which placement is to be evaluated and, optionally, the number of jobs already running on that machine.

The output of the machine learning algorithm 40 is a score that is either the raw KPI of the workload that is to be run on the machine that is currently being considered, compared to running it on a dedicated machine on its own, or is the KPI worsening factor that describes how much worse the application-specific KPI becomes if the workload is to be run on the machine that is currently being considered. By running a prediction for a new workload against the current load of all cluster machines, the machine that provides the best performance is identified.

Whenever a workload is being added to a machine, the continuously measured hardware performance counters of the overall machine load (comprising one or several workloads), as well as the actual KPI for the workload, are collected and form the ground truth of the actual performance of the workload in that environment. If instead of using the raw KPI, the KPI worsening factor is used, it can now be calculated by comparing to the (previously collected in step S1) KPI for the workload on a stand-alone system. Taking the (also collected in step S1) hardware performance counters for a stand-alone run, the hardware performance counters of the machine that it is co-located on with other loads, and, optionally, the number of such loads, gives the same input as for the prediction step, together with the actual KPI or KPI worsening factor that is used as the expected result (label). Thus, training of the machine learning algorithm 40 can be done on newly observed performance behavior of workload applications In other words, the training approach creates training data by measuring the input and output of the machine learning algorithm 40, allowing the machine learning algorithm 40 to predict on the input data, and then feeding that prediction and the actual measured data back so that the machine learning algorithm 40 can update its parameters and thus gradually improve its model and predictions.

The machine learning algorithm 40 employed follows the construction rules of a multi-layer perceptron (MLP). In between the input layer (comprising, as described above, the performance counters of a workload when run on its own, the performance counters of a machine on which one or several other workloads are already running, and optionally the number of the workloads on that machine) and the output layer (that produces as output a single value, the KPI or the KPI worsening factor), there are several hidden dense layers (where each node of a layer is connected to every node at the next layer), each with a non-linear activation function.

In addition to the training phase and prediction phase, there is the phase of characterizing a new workload running in isolation, which only occurs once for each new workload that has never been seen before by the system. During this phase, only data is collected, no training or prediction is done. The data that is collected is the KPI of the application (e.g., KPI_i=10000 requests per second), and the hardware performance counters that result from running this workload on an otherwise idle machine (e.g., PC_i=x). During the training phase, when a workload A (potentially concurrently with other workloads B, C, . . . ) runs on a cluster machine 10a, the hardware performance counters of machine 10a are collected (e.g., PC_ii=y) and are combined with the hardware performance counters measured when workload A was initially run on a machine on its own (PC_i+PC_ii=x+y), thus combining input values that characterize the cluster machine 10a and its current workload with input values that characterize the general behavior of the application. The KPI reached by workload A under these conditions is also measured (e.g., KPI_ii=5000 requests per second). For training of the ML algorithm, the combined hardware performance counters PC_i and PC_ii form the input, and either the raw KPI value KPI_ii, or the KPI worsening factor KPI_i/KPI_ii form the output labels. The ML algorithm can be defined to be trained using either raw KPI values or the KPI worsening factors. Thus, the input and the correct output that the ML algorithm should produce is given so that the ML algorithm can learn the desired output, adapt its weights and parameters, etc. In the prediction phase, the current hardware performance counters on each machine cluster machine 10a, 10b, 10c . . . 10n are collected (e.g., PC_ii, PC_iii, PC_iv . . . PC_n) are collected and each are combined with the hardware performance counters from the system on which the workload to be placed was run in isolation (PC_i). Using these inputs, the ML algorithm predicts a KPI (or KPI worsening factor) as output. According to the output, which cluster machine 10a, 10b, 10c . . . 10n to schedule the workload is selected (e.g., the one that shows the highest predicted KPI or the lowest KPI worsening factor). The workload placement decision can thereby be based on a proper prediction since both parts of the input are available before the workload placement decision is made.

The three phases can run concurrently or at different times. For example, data can be collected for new workloads, while training and prediction is taking place for other workloads. Further, the training and prediction phases can work together to produce online training. For example, a workload A is placed onto a cluster machine 10a according to the workload placement decision in the prediction phase. After it is placed, the KPI is measured, as well as the hardware performance counters of the cluster machine 10a which can be, for example, also concurrently running other workloads B and C. Those two values can then be used to create another input vector for the training phase by combining the measured hardware performance counters (e.g., PC_ii) with the hardware performance counters from when workload A was run on its own (e.g., PC_i), and the measured KPI of the workloads A, B and C running together can be used for the output in the training phase (e.g., KPI_ii).

Embodiments of the present invention provide for the following improvements and advantages:
1) Using values from hardware performance counters from a machine running a target application in isolation, and values from the hardware performance counters values from a target machine where the application may be deployed; feeding such values to a machine learning model with the target of predicting the performance the target application would have if deployed on the target machine; and comparing the obtained prediction with all the predictions obtained for other target machines, in order to select the most suitable machine to the deploy the application on.

a. Providing as input, according to one particular embodiment, to the machine learning model also the number of applications being run on the target machine.

b. Using an artificial neural network as a machine learning model.

c. Using performance counters that include CPU hardware counters.

d. Providing that the target of the prediction is the ratio between the expected performance of the application when running together with the target machine's workload and the performance of the application when running alone on a machine, or providing that the target of the prediction is the KPI value of the target application when running together with the target machine's workload.
2) By using more information and creating models that take into account application behavior, more informed placement decisions for workloads can be provided, thereby optimizing the performance of those workloads.
3) The algorithm does not need any prior knowledge about applications to nevertheless make sophisticated and accurate workload placement decisions.
4) Higher quality workload placement decisions.

According to an embodiment, the present invention provides a method comprising the following steps:
1) Collecting system information as well as application-specific KPI (e.g., throughput, response time, etc.) information, both once for each application to characterize the application, as well as continuously on each machine to characterize the current load on each cluster machine.
2) Combining the application-specific information that was collected once with the information specific to the current load on each cluster machine.
3) Optionally, computing a KPI worsening factor. The KPI worsening factor is an indication of how much worse an application may run in conjunction with other applications.
4) Training a supervised machine learning model (with occasional retraining from additional collected data) that takes 2) as input and either the raw KPI measured in 1) or the KPI worsening factor calculated in 3) as output, based on previous observations of the behavior of workloads co-located on cluster machines.
5) Using the model from 4) to make a prediction that optimizes the placement decision for a new workload that is to be executed on a cluster of machines already running other workloads.

The quality of placement decisions can be improved with the amount of previously collected data about the behavior of co-located workloads. During an initial training phase necessary to create models, a legacy algorithm can be used.

Embodiments of the present invention could be deployed in Cloud and system platform markets, where more efficient placement decisions can reduce the amount of wasted resources and give customers higher performance and faster execution of their workloads.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for allocating a workload to at least one cluster machine of a plurality of cluster machines which are part of a computer cluster operating in a cluster computing environment, the method comprising:
collecting values from hardware performance counters of each of the cluster machines while the cluster machines are running different workloads;
using a value of a hardware performance counter from a system which executed the workload to be allocated in isolation and the values from the hardware performance counters of each of the cluster machines which are running the different workloads as input to a machine learning algorithm trained to provide as output in each case a prediction of a performance of the workload on each of the cluster machines which are running the different workloads; and
selecting the at least one cluster machine for placement of the workload based on the predictions.

2. The method according to claim 1, wherein the machine learning algorithm is trained to provide as the output in each case a key performance indicator (KPI) worsening factor representing a ratio of an expected KPI of the workload on each of the cluster machines which are running the different workloads and a measured KPI from the system which executed the workload to be allocated in isolation, and wherein the at least one cluster machine predicted to have the lowest KPI worsening factor is selected for placement of the workload.

3. The method according to claim 1, wherein the input to the machine learning algorithm further includes in each case a number of the different workloads currently running on each of the cluster machines.

4. The method according to claim 1, wherein the machine learning algorithm uses an artificial neural network as a machine learning model.

5. The method according to claim 1, wherein the values of the hardware performance counters are combined with each other.

6. The method according to claim 1, further comprising:
executing the workload after placement of the workload on the at least one cluster machine concurrently with at least one other workload;
collecting values from the hardware performance counters of the at least one cluster machine and measuring a key performance indicator (KPI) while the at least one cluster machine executes the workload concurrently with the at least one other workload; and
using the values of the hardware performance counters of the at least one cluster machine and the measured KPI as training data for the machine learning algorithm.

7. The method according to claim 1, wherein the machine learning algorithm follows construction rules of a multi-layer perceptron.

8. The method according to claim 1, further comprising executing a new workload in the system in isolation, or in another system or one of the cluster machines in isolation, and collecting values from the hardware performance counters during execution of the new workload.

9. The method according to claim 1, further comprising receiving a user-specified key performance indicator (KPI) characterizing the performance of the workload.

10. A system for allocating a workload to at least one cluster machine of a plurality of cluster machines which are part of a computer cluster operating in a cluster computing environment, the system comprising memory and one or more computer processors which, alone or in combination, are configured to provide for execution of a method comprising:
collecting values from hardware performance counters of each of the cluster machines while the cluster machines are running different workloads;
using a value of a hardware performance counter from a system which executed the workload to be allocated in isolation and the values from the hardware performance counters of each of the cluster machines which are running the different workloads as input to a machine learning algorithm trained to provide as output in each case a prediction of a performance of the workload on each of the cluster machines which are running the different workloads; and
selecting the at least one cluster machine for placement of the workload based on the predictions.

11. The system according to claim 10, wherein the machine learning algorithm is trained to provide as the output in each case a key performance indicator (KPI) worsening factor representing a ratio of an expected KPI of the workload on each of the cluster machines which are running the different workloads and a measured KPI from the system which executed the workload to be allocated in isolation, and wherein the at least one cluster machine predicted to have the lowest KPI worsening factor is selected for placement of the workload.

12. A tangible, non-transitory computer-readable medium having instructions thereon which, upon execution by one or more processors with access to memory, provides for execution of the method according to claim 1.

13. A method for training a machine learning algorithm for use in allocating workloads to cluster machines which are part of a computer cluster operating in a cluster computing environment, the method comprising:
collecting values from hardware performance counters of each of the cluster machines which are running a first workload concurrently with other workloads and measuring a key performance indicator (KPI) while the cluster machines are running the first workload;
combining the values from the hardware performance counters of each of the cluster machines in each case with a value from a hardware performance counter of a system that executed the first workload in isolation; and
providing the combined values from the hardware performance counters in each case as input to the machine learning algorithm and using the measured KPI for output labels such that the machine learning algorithm adapts its weights and parameters based thereon.

14. The method according to claim 13, wherein the output labels are in each case a KPI worsening factor representing a ratio of the measured KPI of the first workload on each of the cluster machines and a measured KPI from the system which executed the first workload in isolation.

15. A tangible, non-transitory computer-readable medium having instructions thereon which, upon execution by one or more processors with access to memory, provides for execution of the method according to claim 13.
